(19) United States
(12) Patent Application Publication
(10) Pub. No.: US 2004/0200773 A1
(43) Pub. Date: Oct. 14, 2004

(54) Microbial generator for bioaugmentation of wastewater streams, wastewater bodies, groundwaters and other aqueous discharges

(76) Inventors: Clifford Lynn Gibbs, Gunter, TX (US); Sasha John Peggs, Jupiter, FL (US)

Correspondence Address: Clifford Lynn Gibbs, 703 Doris Lane, Gunter, TX, 75058, US

(21) Appl. No.: 10/409,784

(22) Filed: Apr. 8, 2003

(51) Int. Cl. C02F 3/02

(52) U.S. Cl. 210/610; 210/620; 210/205

(57) ABSTRACT

The invention relates to a highly efficient, microbial generator, bio-reactor or bio-generator that optimizes the bioaugmentation of wastewater streams, wastewater bodies, ground-waters and other aqueous discharges by generating and dispensing active, non-dormant microbes at the point or site of bioaugmentation in sufficient quantities, types, and rates that overcomes the inadequacies and cost prohibitions of prior available methods.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to a microbial generator that optimizes the bioaugmentation of wastewater streams, wastewater bodies, ground-waters, and other aqueous discharges. In particular, it relates to a microbial generator, bio-generator or bioreactor, at the point or site of bioaugmentation that improves the efficiency of bioaugmentation, i.e., the increased concentration, and rate, of bacteria added to the wastewater.

Organic pollutants from diverse agricultural, municipal and industrial facilities, and waste sites partition preferentially into the water or air and spread rapidly throughout the environment. Many of these materials and gases, even in small concentrations, adversely affect life forms, and create serious environmental threats. Toxicity, carcinogenicity, and mutagenicity are the most critical biological properties of a potential pollutant, a very large number of which have been identified by the U.S. Environmental Protection Agency as particularly threatening. For example the widespread inability by municipalities to meet the wastewater effluent requirements of the federal and state agencies has resulted in serious problems to the nations' rivers and streams as well as placed a very large financial burden on the municipalities. And for example the widespread inability by municipalities and industry to control odors has resulted in serious odor complaints by state and federal agencies as well as neighbors of these facilities. And for example the widespread corrosion damage to equipment, concrete structures and piping caused by hydrogen sulfide (H₂S) and other gases emitting from the wastewater has resulted in catastrophic failures of the wastewater collection and treatment facilities and costly replacements. And for example the widespread problematic and costly disposal of sludge (biosolids) has resulted in serious pollution problems as well as disposal site shortages.

Bioaugmentation is the use of selected strains of microbes isolated from the environment to improve some of the processes involved in traditional waste treatment. This technology has been known for decades. Some major drawbacks of bioaugmentation are the need for an acclimation period prior to onset of biodegradation, and short survival or lack of growth of microbial inocula in the delivery systems. Various prior art methods of bioaugmentation of wastewater streams, wastewater bodies, ground-waters and other aqueous discharges has been practiced for a number of years using various methods, various microbes and microbes in various states of inactivity or dormancy. In each case the microbes are generated at a central site, put into various states of inactivity or dormancy for preservation and shipped to the user location for application by a traditional delivery system. In each case, the cost of preservation and handling can be a major portion of the overall cost of bioaugmentation. In the case of microbes in a preserved or dormant state, a period of time is required for the microbes to become active after the microbes are applied to the wastewater streams, wastewater bodies, ground-waters and other aqueous discharges, causing delays in the onset of biodegradation and metabolism of the waste.

U.S. Pat. No. 5,578,211 discloses an attempt to provide workable means of bioaugmentation of a wastewater collection piping system. The patent holder describes a method comprising: introducing select microbes into said piping system at a frequency corresponding to the pumping activity of said pumping stations, and in an amount proportional to the surface area of said interior surface of said piping system wherein said select microbes are capable of completely consuming said predominant waste material in said wastewater and wherein an anaerobic biomass comprising almost entirely said select microbes is formed along said interior surface of said piping system wherein said microbes are introduced in an initially non-active state. The patent holder adds microbes to the collection system in a dormant state similar to all previous attempts at bioaugmentation. The patent holder specifically refers to the use of a dosing station that can have a five-liter bag and a battery-power, microprocessor-controlled pump which adds a small, predetermined amount of concentrate according to a specific dosing schedule coinciding with the forced main pumping operation. The predominant waste matter delivered to a wastewater treatment facility by a collection piping system is inert and can not be completely consumed by known microbes. Even if microbes capable of completely consuming the predominant waste material in wastewater were available as claimed, the method is subject to problems of determination of dosing amount and inactive or dormant microbes and is limited to a piping system with an interior surface having a biomass. This method of bioaugmentation is inherent with problems and extensive cost as previously discussed. The patent holder points out that his method and prior art methods of using normal commercial concentrates would be prohibitively expensive. The patent holder's method depends on microbes suspended in spore state concentrated or compressed to 10.sup.14 microbes/cubic mm and higher. The patent holder uses the term microbes/cu. mm (cubic millimeter) to describe concentration of his spore state microbes.

One cu mm is equal to 1×10⁹ μm³ (1×10 to the 9^{th} power micrometers cubed). In order to get 1×10¹⁴ microbes (concentration claimed by the patent holder) into 1×10⁹ μm³, the volume of a single microbe must be 1×10⁻⁵ μm³. Ovoid spores (such as those produced by Bacillus species used in the bioaugmentation of wastewater), typically have a length more than twice its diameter. The approximate dimensions of a typical small Bacillus spore are 1.0 μm in length with a diameter of 0.5 μm. This would result in a Bacillus spore volume of 0.13 μm³. Therefore, the microbes in this U.S. Pat. No. 5,578,211 patent claim would have to be 13,000 times smaller than Bacillus spores, bacterial DNA, even smaller than some of the smaller known viruses. One could not see the patent holder's “bacteria” with a regular light microscope; one would have to use an electron microscope. Even if the concentrations of microbes in concentrate were available as claimed, the method is subject to problems of determination of dosing amount and inactive or dormant microbes. This method of bioaugmentation is inherent with problems, impossible claims and extensive costs as previously discussed.

U.S. Pat. No. 5,588,841 discloses an attempt to provide workable means of bioaugmentation of a wastewater collection piping system. The patent holder describes a method comprising: introducing select microbes into said piping system in an amount proportional to the surface area of said interior surface of said piping system wherein said select microbes are capable of completely consuming said predominant waste material in said wastewater, until a biomass comprising almost entirely said select microbes is formed along said interior surface of said piping system wherein said microbes are introduced in an initially non-active state. The patent holder adds microbes to the collection system in a dormant state similar to all previous attempts at bioaugmentation. The patent holder specifically refers to the use of; a dosing station can have a five-liter bag and a battery-power, microprocessor-controlled pump which adds a small, predetermined amount of concentrate according to a specific dosing schedule coinciding with the forced main pumping operation. The predominant waste matter delivered to a wastewater treatment facility by a collection piping system is indigestible and can not be completely consumed by known microbes. Even if microbes capable of completely consuming the predominant waste material in wastewater were available as claimed, the method is subject to problems of determination of dosing amount and inactive or dormant microbes and is limited to a piping system with an interior surface having a biomass. This method of bioaugmentation is inherent with problems and extensive costs as previously discussed. The patent holder points out that his method and prior art methods of using normal commercial concentrates would be prohibitively expensive. The patent holder's method depends on microbes concentrated or compressed to 10.sup.13 microbes/cubic mm and higher. The patent holder uses the term microbes/cu. mm (cubic millimeter) to describe concentration of spore state microbes. One cu mm is equal to 1×10⁹ μm³ (1×10 to the 9^{th} power micrometers cubed). In order to get 1×10¹³ microbes (concentration claimed by the patent holder) into 1×10⁹ μm³, the volume of a single microbe must be 1×10⁻⁴ μm³. Ovoid spores (such as those produced by Bacillus species used in bioaugmentation of wastewater), typically have a length more than twice its diameter. The approximate dimensions of a typical small Bacillus spore are 1.0 μm in length with a diameter of 0.5 μm. This would result in a Bacillus spore volume of 0.13 μm³. Therefore, the microbes in this U.S. Pat. No. 5,588,841 patent claim would have to be 1,300 times smaller than Bacillus spores, bacterial DNA, even smaller than some of the smaller known viruses. One could not see the patent holder's “bacteria” with a regular light microscope; one would have to use an electron microscope. Even if the concentrations of microbes in concentrate were available as claimed, the method is subject to problems of determination of dosing amount and inactive or dormant microbes and is limited to a piping system with an interior surface having a biomass. This method of bioaugmentation is inherent with problems and extensive cost as previously discussed.

Another form of bio-remediation is widely practiced where the waste stream itself is put into a bioreactor with a high surface area mobilized bed to remove the pollutants from the wastewater streams, wastewater bodies, ground-waters and other aqueous discharges. Various materials are used that are porous and impregnated with a matrix of bacteria for cleaning the waste stream. These bioreactors experience a high degree of fouling due to the plugging of the mobilized bed and are impractical for use on high volume streams. These bioreactors are impractical for use on high wastewater volumes such as municipal wastewater collection systems because of the required size, cost and other limitations.

U.S. Pat. No. 6,254,785 discloses a method for treating contaminated groundwater by providing a treatment media within a passive hydraulic communication, whereby said contaminated water flows through said treatment media prior to discharging. This apparatus uses indigenous microbes rather than bioaugmentation of select microbes and is impractical for use on high wastewater volumes such as municipal wastewater collection systems because of the required size, cost and other limitations.

Another form of bio-remediation is widely practiced where grease traps are bioaugmented for improved performance. These bioreactors are impractical for use on high wastewater volumes such as municipal wastewater collection systems because of their specialty application on small grease traps.

U.S. Pat. No. 5,516,687 discloses a bacterial incubator used for degrading organic waste and, more specifically a method and device for maintaining an effective bacterial level within the collecting chamber of an organic matter collection system. The inventor specifically describes an apparatus for collecting the organic waste for treatment, rather than an apparatus for bioaugmentation of an in-situ wastewater stream, wastewater body, groundwater or other aqueous discharges.

U.S. Pat. No. 6,207,056 discloses a method for controlling the accumulation of a predetermined waste product thereby maintaining fluid flow in a grease trap. The inventor specifically describes a portable apparatus adapted for maintaining a substantial percentage of the members of a microbial culture by growing a microbiological culture in the apparatus at the site of a grease trap to be maintained in the presence of an organic nutrient chemically similar to a waste product the accumulation of which is to be controlled periodically discharging an amount of the microbiological culture into the grease trap. The inventor describes a portable apparatus for providing injection of microbial cultures into a grease trap, which greatly increases the normally required time between removal of accumulated grease.

There remains a need for microbial generators of improved design for the generation of microbes at the bioaugmentation point or site that delivers active, non-dormant microbes in sufficient quantities, types, and rates to the wastewater streams, wastewater bodies, ground-waters and other aqueous discharges that overcomes the inadequacies and cost prohibitions of the available methods.

### BRIEF SUMMARY OF THE INVENTION

It is accordingly, a primary objective of this invention to overcome prior art disadvantages and satisfy these and other needs.

In particular, it is the first object to provide a novel, highly efficient, microbial generator for achieving high concentrations and volumes of active microbes for bioaugmentation of wastewater streams, wastewater bodies, ground-waters or other aqueous discharges at the site of the bioaugmentation.

It is the second and more specific object to provide a microbial generator, as characterized, and a bioaugmentation method useful for the continuous mineralization and biodegradation of waste, odor control, corrosion control and improved digestion efficiency in wastewater streams, wastewater bodies, ground-waters and other aqueous discharges by optimum application of non-dormant microbes at frequencies and quantities unaffordable and impractical by prior art methodology.

The third object of the present invention is to provide an economical microbial generator for in-situ bioaugmentation which can be operated by unskilled personnel.

These objects and others are achieved in accordance with the present invention that embodies a microbial generator useful in facilitating, improving, or achieving the bioaugmentation of active microbes into a wastewater stream, wastewater body, groundwater or other aqueous discharges for the purposes of gas reduction, mineralization and biodegradation.

The apparatus, in a more preferred aspect, is comprised generally of an initial, or first chamber(s), generally termed a bioreactor or bio-generator, with a liquid quantity regulated by a float valve, overflow, timer or sensor, an air or oxygen transfer apparatus, a source of microbes, a source of nutrients/food, a vent, an overflow and a drain. The apparatus further includes an optional second chamber(s) that is linked to the drain of the first chamber(s) and is comprised of an air or oxygen transfer apparatus, a vent, an overflow and a drain. The apparatus further includes methods on the drain(s) of each chamber(s) for regulation of bioaugmentation from one or all chambers.

In this more preferred form, the fist chamber(s) is attached to a potable water source and filled using a float valve, overflow, timer or sensor. The nutrient/food supply and the microbe supply are metered into the chamber by electronic, gravity or mechanical means. An aerator supplies air or oxygen to the said liquid sufficient enough to create an aerobic condition for the survival and growth of the microbes. It is necessary to provide a vent to exhaust the injected air or oxygen. During the growth of microbes, considerable foaming will result, requiring an overflow drain. Not required but for this reason, and others, the vent and overflow are combined. The positive pressure generated by the airflow of the aerator will prevent alien microbes and pollutants from contaminating the chamber(s). At a predetermined interval, the first chamber(s) empties into the second chamber(s) by electrical, gravity or mechanical means. An aerator supplies air or oxygen to the liquid in the second chamber(s) sufficient enough to create an aerobic condition for the survival and growth of the microbes. It is necessary to provide a vent to exhaust the injected air of the second chamber(s). During the continued growth of the microbes in the second chamber(s), considerable foaming will result. For this reason, and others, the vent and overflow of the second chamber(s) are combined. The positive pressure generated by airflow of the aerator will prevent alien microbes from contaminating the chamber(s). The apparatus further includes methods on the drain(s) of the second chamber(s) for regulation of bioaugmentation.

The apparatus, in one of its aspects, is comprised generally of an initial chamber(s), generally termed a bioreactor or bio-generator, with a liquid quantity regulated by a float valve, overflow, timer or sensor, an air or oxygen transfer apparatus, a source of microbes, a source of nutrients/food, a vent, an overflow and a drain. The apparatus further includes methods on the drain(s) of the chamber(s) for regulation of bioaugmentation from one or all chambers.

In this preferred form, the chamber(s) is attached to a potable water source and filled using a float valve, overflow, timer or sensor. The nutrient/food supply and the microbe mixture are metered into the chamber by electronic, gravity or mechanical means. An aerator supplies air or oxygen to the said liquid sufficient enough to create an aerobic condition for the survival and growth of the microbes. It is necessary to provide a vent to exhaust the injected air. During the growth of microbes, considerable foaming will result, requiring an overflow drain. Not required but for this reason, and others, the vent and overflow are combined. The positive pressure generated by the airflow of the aerator will prevent alien microbes and pollutants from contaminating the chamber(s).

The invention is found particularly useful in bioaugmentation of wastewater collection systems for odor control, gas reduction, biosolids reduction, corrosion reduction, decreased pump times and treatment efficiency where very frequent injections of microbes are necessary to create good competitive exclusion and bioaugmentation of all of the wastewater in fast turnover wastewater. Prior art frequencies of once per hour to once per day or less have proven to be inadequate in most odor control, gas reduction, biosolids reduction, pump time reduction and corrosion reduction situations.

A key factor of the present invention is the exponential growth (also known as logarithmic growth) of the microbes increases in a direct proportion to time such that the microbes remains active and the microbial generator delivers a high concentration of active microorganisms to the site being bioaugmented.

A preferred microbial generator and the principles of operation of said microbial generator for bioaugmentation of active microbes would be more fully understood by reference to the following detailed description and to the drawing to which reference is made in the description. The various features and components in the drawing are referred to by numbers, similar features and components being represented in the view by similar numbers.

### BRIEF DESCRIPTION OF THE SEVERAL VIEWS OF THE DRAWING

It is to be understood that the drawings are to be used for the purpose of illustration only and not as a definition of the limits of the invention.

In the drawings, similar reference characters denote similar elements throughout the views.

FIG. 1 is a view of an embodiment of the microbial generator invention utilizing a first chamber and a second chamber

FIG. 2 is a view of an embodiment of the microbial generator of the invention utilizing a first chamber.

FIG. 3 is a flow chart illustrating the method of the present invention..

### DETAILED DESCRIPTION OF THE INVENTION

In the Drawings:

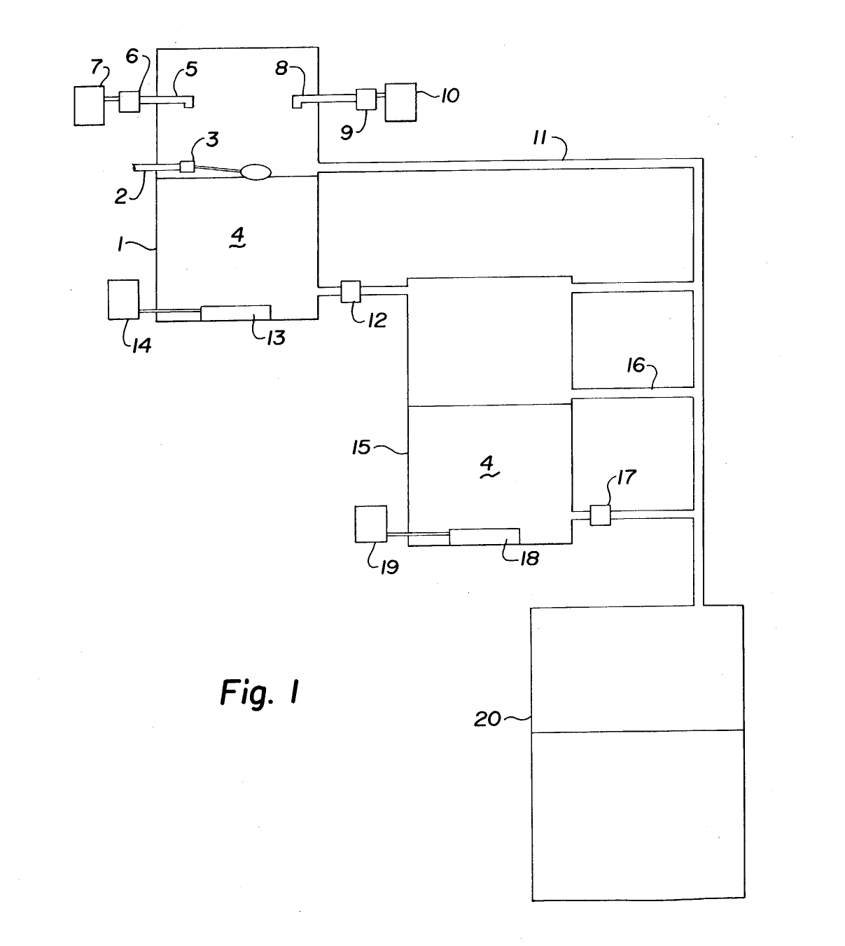

FIG. 1 depicts the combination of a microbial generator and a second chamber reactor. The combination is constituted generally of a microbial generator, a second chamber reactor and the connection to a wastewater stream, a wastewater body, a groundwater site or any other aqueous discharge. The unit as a whole further includes the first chamber(s) where the microbes are grown for a long period of time, usually 12 hours or longer, a second chamber(s) where the microbes continue growth and are metered to the wastewater stream, wastewater body, groundwater or other aqueous discharges continuously or very frequently, usually every 15 minutes or less, or at the frequency necessary to bioaugment all of the wastewater.

Referring to FIG. 1, the microbial generator is constituted of a container 1, an inlet for water or liquid 2 attached to a spray nozzle, float valve, timer or sensor 3 so as to create a predetermined amount of liquid 4. An inlet for microbes 5 attached to a metering valve 6 and a supply of microbes 7. An inlet for nutrients/food 8 attached to a metering valve 9 and a supply of nutrients/food 10. A combined air vent and overflow pipe 11 attached to the bioaugmentation site 20 which contains a wastewater stream, wastewater body, groundwater or other aqueous discharges to be bioaugmented. A metering valve 12 that empties the container 1 of the body of liquid 4 at predetermined intervals. A bubblier 13 for the transfer of oxygen into the liquid 4, attached to an air and/or oxygen supply pump 14.

Referring to FIG. 1, the microbial generator attached to a second container 15, a combined air vent and overflow pipe 16 attached to the bioaugmentation site 20. A metering valve 17 that bioaugments the bioaugmentation site 20 at predetermined intervals. A bubblier 18 for the transfer of oxygen into the liquid 4 attached to an air and/or oxygen supply pump 19. Air and/or oxygen supply 14 and 19 can be one or two as shown.

Referring to FIG. 1, the second chamber 15 is especially advantageous for large sites when frequent or continuous bioaugmentation is desired and the microbial generator container 1 has a constant level valve, timer or sensor 3 such that the liquid 4 would be diluted with water from the water source 2 each time the metering valve 12 dispenses liquid 4 into the bioaugmentation site 20. A preferred method incorporates a second chamber 15 that receives the entire liquid 4 from the container 1 through metering valve 12 at predetermined times like every twelve hours.

In this preference, the second chamber 15 would be filled to overflow pipe 16 every twelve hours with liquid 4 from first chamber 1 and emptied every twelve hours at frequent intervals or continuously by metering valve 17.

After the container 1 is emptied of liquid 4 by metering valve 12, it is refilled with water from inlet 2 to required level by valve 3. During the refilling of container 1 or shortly after, microbes 7 are added into the liquid 4 through metering valve 6 and inlet 5. During the refilling of container 1, or shortly after, nutrients/food 10 are added into the liquid 4 through metering valve 9 and inlet 8.

Air and/or oxygen supplied by pump 14 and 19 to containers 1 and 15 must be exhausted from containers 1 and 15. A preferred method is through vents 11 and 16 to bioaugmentation site 20. Alien microbes from the surrounding atmosphere and/or the bioaugmentation site 20 will be unable to contaminate liquid 4 due to the positive pressure created by the air and/or oxygen pumps 14 and 19 through diffusers 13 and 18 and exhausted through vents 11 and 16.

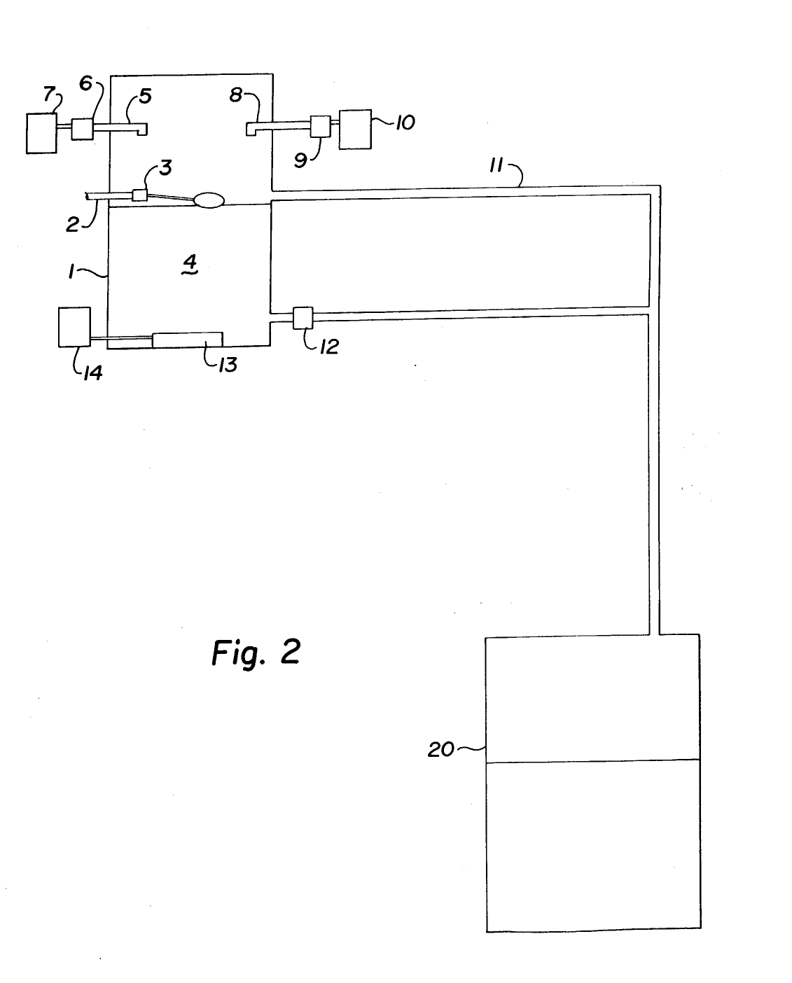

FIG. 2 depicts a microbial generator, bio-generator or bioreactor.. The microbial generator is constituted generally of an apparatus, connection to a wastewater stream, a wastewater body, a groundwater site or any other aqueous discharge for the purpose of bioaugmentation. The apparatus as a whole further includes the first chamber(s) where the microbes are grown for a long period of time, usually 12 hours or longer, and are metered to the wastewater stream, wastewater body, groundwater or other aqueous discharges continuously or very frequently, usually every 15 minutes or less, or at the frequency necessary to bioaugment all of the wastewater.

Referring to FIG. 2, the microbial generator is constituted of a container 1, an inlet for water or liquid 2 attached to a float valve, timer or sensor 3 so as to create a predetermined amount of liquid 4. An inlet for microbes 5 attached to a metering valve 6 and a supply of microbes 7. An inlet for nutrients/food 8 attached to a metering valve 9 and a supply of nutrients/food 10. A combined air vent and overflow pipe 11 attached to the bioaugmentation site 20 which contains a wastewater stream, wastewater body, groundwater or other aqueous discharges to be bioaugmented. A metering valve 12 that meters the liquid 4 to the bioaugmentation site 20 at predetermined intervals. A bubblier 13 for the transfer of oxygen into the liquid 4, attached to an air and/or oxygen supply pump 14.

In this preference, the container 1 would be filled to the predetermined amount by float vale, timer or sensor 3 and liquid 4 would be metered to the bioaugmentation site 20 at frequent intervals or continuously by metering valve 12. Each time a portion of liquid 4 is metered to the bioaugmentation site 20, float valve, timer or sensor 3 refills the container 1 to the predetermined amount. At predetermined intervals, microbes 7 would be metered to the liquid 4 by metering valve 6 through inlet 5. At predetermined intervals, nutrient/food 10 would be metered to the liquid 4 by metering valve 9 through inlet 8. Microbes 7 and nutrient/food 10 are metered to liquid 4 at the predetermined intervals for maintaining effective microbial levels within liquid 4.

Air and/or oxygen supplied by pump 14 to container(s) 1 must be exhausted from container(s) 1. A preferred method is through vent 11 to bioaugmentation site 20. Alien microbes from the surrounding atmosphere and/or the bioaugmentation site 20 will be unable to contaminate liquid 4 due to the positive pressure created by the air and/or oxygen pump 14 through diffuser 13 and exhausted through vent 11.

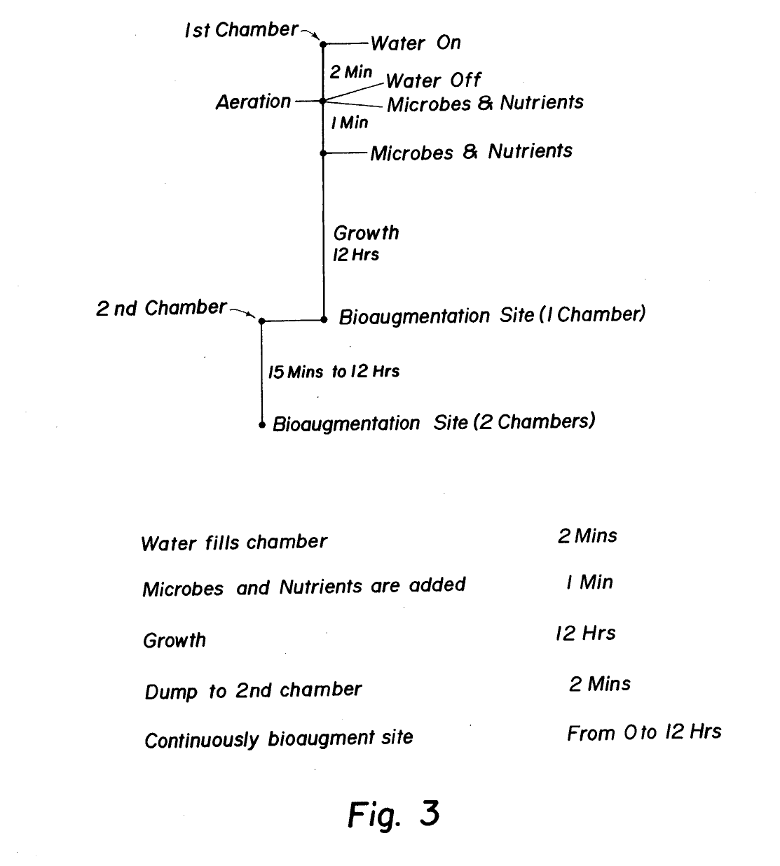

FIG. 3 depicts a flow chart means for bioaugmentation of a site utilizing a microbe generator as described in FIG. 1 and/or FIG. 2 or other types of microbe generators that deliver active microbes to a wastewater stream, wastewater body, groundwater or other aqueous discharges continuously or very frequently. The chamber(s) are filled to a prescribed level with water. Microbes, Nutrients/food and aeration are added so as to achieve desired microbe growth within a desired length of time. This example is 12 hours. The mixture is metered to a bioaugmentation site from the 1^{st} chamber or to a 2nd chamber. If a 2nd chamber is utilized, the mixture is metered from the 2nd chamber to the bioaugmentation site. This example is 15 minutes to 12 hours.

While only several embodiments of the present invention have been shown and described, it is obvious that many changes and modifications may be made thereunto without departing from the spirit and scope of the invention which is to bioaugment wastewater streams, wastewater bodies, ground-waters and other aqueous discharges with active microbes.

The following is illustrative, and exemplifies the best mode of operating a preferred microbial generator at the site of bioaugmentation, as employed in the practice of this invention. The microbial generator, bio-generator and/or bioreactor employed are those described by reference to FIG. 1.

### EXAMPLE

Until the present invention, there has not been an effective and affordable means of bioaugmentation of wastewater streams, wastewater bodies, ground waters and other aqueous discharges. Prior to the present invention, every attempt at bioaugmentation of wastewater streams, wastewater bodies, ground-waters and other aqueous discharges involved microbes grown in an off-site microbial generator and the introduction of said microbes to the bioaugmentation point or site were in an initially non-active liquid or solid state. In this example of the invention, the microbial generator was set up at the wet well of a pump station in Blue Springs, Mo., to bioaugment the municipal wastewater stream with a large quantity of active microbes. The microbial generator consisted of two chambers as described in FIG. 2 and an enclosure for security at the said pump station. The first chamber inlet was connected to the potable city water. The float valve on the inlet was set at approximately 10 gallons. Karma Cleaning Systems, Inc., supplied a nutrient/food supply and a microbe mixture of aerobic and facultatively anaerobic Bacillus species. The timers on the nutrient/food supply and the microbe mixture were set to add nutrients/food and microbes after the first chamber was refilled with water to the predetermined 10 gallons. An aerator, consisting of an air pump and an inlet filter, for supplying air to both chambers was connected so that it supplied air 100 percent of the time to both chambers. The aerators were attached to diffusers in each chamber to ensue good transfer of oxygen into the liquid. The timer on the first chamber drain was set so that the first chamber drained into the second chamber every twelve hours. After the first chamber drained into the second chamber, the first chamber refilled with water and received nutrients/food and microbes repeating the cycle. The microprocessor controlled pump on the second chamber outlet was adjusted so that the wetwell of the pump station was bioaugmented every fifteen minutes. The length of time that the said pump ran, after it came on every fifteen minutes, was adjusted so that the second chamber was empty by the time the first chamber drained into it again (12 hours). The chambers were sealed such that the air from both chambers exited through a combined exhaust and overflow pipe into the pump station wetwell. Thus creating positive air pressure so that no alien microbes or contaminants could enter either chamber.

The length of time that the microbes multiplied, in the present example of the invention, was 12 hours in the first chamber and from 15 minutes to 12 hours in the second chamber. The concentration of the microbes entering the wetwell measured in excess of 10⁸ CFU/ml on every occasion that measurements were taken. Periodic service and maintenance consisted of cleaning the chambers and their components and replenishment of the nutrient/food supply and microbe mixture.

In this present example the pump station wetwell received 20 gallons of highly concentrated active microbes per day, at a very reasonable expense.

Another microbial generator of this invention was installed at a wet well of a pump station in Fort Smith, Ark. In both examples biosolids produced by the wastewater treatment plants in Blue Springs, Mo. and Fort Smith, Ark. were reduced by over 35%, odors were reduced, grease and scum problems were eliminated as well as other benefits prohibitive by prior art methodology.

Having described the invention, what is claimed is:

1. An apparatus for bioaugmenting wastewater streams, wastewater bodies, ground-waters and any other aqueous discharges comprising:
(a) a first chamber(s) having at least one inlet for water or liquid utilizing a method to control the fill level of the chamber(s), a source of nutrients/food, a source of microbes and a source of air or oxygen, an overflow, a vent, an outlet; and
(b) a second chamber(s) having at least one inlet to receive liquid from the first chamber(s), a source of air or oxygen, an overflow, a vent and an outlet attached to a metering device to control the bioaugmentation of wastewater streams, wastewater bodies, ground-waters and any other aqueous discharges wherein said microbes are introduced in an active state.

2. The apparatus of claim 1 wherein only one chamber is utilized wherein the chamber(s) has an outlet attached to a metering device(s) to control the bioaugmentation of wastewater streams, wastewater bodies, ground-waters and any other aqueous discharges wherein said microbes are introduced in an active state.

3. The apparatus of claim 1 wherein any novel microbial generator(s), bio-generator(s) or bioreactor(s) is used for the purpose of bioaugmentation of wastewater streams, wastewater bodies, ground-waters and any other aqueous discharge wherein said microbes are introduced in an active state.

4. The apparatus of claim 2 wherein any novel microbial generator(s), bio-generator or bioreactor is used for the purpose of bioaugmentation of wastewater streams, wastewater bodies, ground-waters and any other aqueous discharge wherein said microbes are introduced in an active state.

5. The apparatus of claim 1 wherein the bioaugmentation of wastewater streams, wastewater bodies, ground-waters and any other aqueous discharges with active microbes are bioaugmented frequent, more frequent, less frequent or continuously.

6. The apparatus of claim 2 wherein the bioaugmentation of wastewater streams, wastewater bodies, ground-waters and any other aqueous discharges with active microbes are bioaugmented frequent, more frequent, less frequent or continuously.

7. The apparatus of claim 3 wherein the bioaugmentation of wastewater streams, wastewater bodies, ground-waters and any other aqueous discharges with active microbes are bioaugmented frequent, more frequent, less frequent or continuously.

8. The apparatus of claim 4 wherein the bioaugmentation of wastewater streams, wastewater bodies, ground-waters and any other aqueous discharges with active microbes are bioaugmented frequent, more frequent, less frequent or continuously.

9. A means for performing bioaugmentation of a site which comprises:
(a) Filling a container with an aqueous liquid, preferably water;
(b) adding microbes;
(c) adding nutrients/food;
(d) aerating the liquid so as to achieve a desired level of dissolved oxygen;
(e) metering said liquid into a bioaugmentation site.

10. A method as recited in claim 9 wherein the step(s), metering said liquid into a bioaugmentation site, includes means for metering into additional chamber(s), and metering of said liquid into a bioaugmentation site(s) utilizes the additional chamber(s).

11. A method as recited in claim 9 where the metering said liquid contains active microbes.

12. A method as recited in claim 10 where the metering said liquid contains active microbes.
